(19) United States
(12) Patent Application Publication
(10) Pub. No.: US 2024/0006113 A1
(43) Pub. Date: Jan. 4, 2024

(54) INDUCTOR AND INDUCTOR MANUFACTURING METHOD

(71) Applicant: DARFON ELECTRONICS CORP., Taoyuan City (TW)

(72) Inventors: Zuei-Chown Jou, Taoyuan City (TW); Chih-Ho Liu, Taoyuan City (TW); Jui-Wen Kuo, Taoyuan City (TW); Chi-Ming Huang, Taoyuan City (TW); Bo-Yu Huang, Taoyuan City (TW); Yao-Tsung Chen, Taoyuan City (TW)

(73) Assignee: DARFON ELECTRONICS CORP., Taoyuan City (TW)

(21) Appl. No.: 18/205,564

(22) Filed: Jun. 4, 2023

(30) Foreign Application Priority Data
Jul. 1, 2022 (TW) 111124718

(51) Int. Cl. H01F 27/28; H01F 27/29; H01F 27/32; H01F 41/10; H01F 41/02

(52) U.S. Cl. CPC H01F 27/2828; H01F 27/292; H01F 27/327; H01F 41/10; H01F 41/0246

(57) ABSTRACT

An inductor includes a coil, a conductive lead frame, and a housing. The coil includes a coil body and a lead protruding from the coil body. The lead has a U-bend portion. The lead is electrically fixed onto the conductive lead frame. The housing encapsulates the coil and exposes the conductive lead frame. A method of manufacturing an inductor includes the following steps: providing a coil, providing a conductive lead frame, making a lead of the coil be electrically fixed onto the conductive lead frame, bending the lead to form a U-bend portion and make the main body of the coil close to a portion of the lead that connects with the conductive lead frame, and forming a housing to encapsulate the coil and expose the conductive lead frame.

### BACKGROUND OF THE INVENTION

### 1. Field of the Invention

The present invention relates to inductors and manufacturing method therefor, and more particularly to one-piece inductors and manufacturing method therefor.

### 2. Description of the Prior Art

A one-piece inductor is formed by embedding a coil in a compressed, cured soft magnetic composite to provide electrical characteristics. Two ends of the coil inside the inductor body are connected to a conductive lead frame by spot welding; the portions of the conductive lead frame exposed outside the inductor body can be used as electrodes for being soldered onto a printed circuit board.

When the size of the inductor is reduced, if the spot welding position of the conductive lead frame and the coil is too close to the coil body, the welding head of a spot welding machine is likely to touch the coil body during the spot welding, causing the insulation layer of the coil to be damaged, resulting in a short circuit of the inductor. In order to avoid the above problem, it is necessary to reduce the space designed for the coil, which will reduce the electrical specifications of the inductor (increasing resistance, decreasing superimposed current).

### SUMMARY OF THE INVENTION

An objective of the invention is to provide an inductor. A lead of a coil of the inductor has a U-bend portion, which can effectively prevent the welding head from touching the coil body during spot welding, and can increase the space designed for the coil.

An inductor according to the invention includes a coil, a conductive lead frame, and a housing. The coil includes a coil body and a lead protruding from the coil body. The lead has a U-bend portion. The lead is electrically fixed to the conductive lead frame. The housing encapsulates the coil and exposes the conductive lead frame. Thereby, the coil is provided with a longer lead, which facilitates the electrical connection between the lead and the conductive lead frame. For example, during spot welding, the electrodes of the spot welding machine can easily avoid touching the coil body. The structural configuration of the inductor is also conducive to reducing the size of the inductor.

An objective of the invention is to provide an inductor manufacturing method. The inductor manufacturing method is to bend a lead of a coil to move the body of the coil to a predetermined position after the lead is electrically fixed, helping a housing that is formed later encapsulate the coil.

An inductor manufacturing method according to the invention includes the following steps: providing a coil, the coil comprising a coil body and a lead protruding from the coil body; providing a conductive lead frame; making the lead be electrically fixed on the conductive lead frame; bending the lead so that the lead forms a U-bend portion and the coil body is close to a portion of the lead that connects with the conductive lead frame; and forming a housing to encapsulate the coil and expose the conductive lead frame. Thereby, during the process of electrically fixing the lead, the coil body is relatively far away from the portion of the lead used for being fixed, which facilitates the fixing of the lead and can easily prevent the coil body from being touched. This feature of the method is also conducive to the manufacture of small-sized inductors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an inductor according to a first embodiment.

FIG. 2 is a schematic diagram illustrating the inductor in FIG. 1 without its housing.

FIG. 3 is an exploded view of the inductor in FIG. 2.

FIG. 4 is a schematic diagram illustrating the connection of a coil and a first conductive lead frame of the inductor in FIG. 2 from a side view.

FIG. 5 is a bottom view of the coil in FIG. 3.

FIG. 6 is a schematic diagram illustrating the connection of a coil and a first conductive lead frame of an inductor according to another embodiment from a side view.

FIG. 7 is a schematic diagram illustrating an inductor according to a second embodiment.

FIG. 8 is a schematic diagram illustrating the inductor in FIG. 7 without its housing.

FIG. 9 is an exploded view of the inductor in FIG. 8.

FIG. 10 is a flowchart of an inductor manufacturing method according to a third embodiment.

FIG. 11 is a schematic diagram illustrating a coil provided according to the inductor manufacturing method.

FIG. 12 is a schematic diagram illustrating a first conductive lead frame and a second conductive lead frame according to the inductor manufacturing method.

FIG. 13 is a schematic diagram illustrating that the coil is electrically fixed on the first conductive lead frame and the second conductive lead frame according to the inductor manufacturing method.

FIG. 14 is a schematic diagram illustrating that first and second leads of the coil are bent according to the inductor manufacturing method.

FIG. 15 is a schematic diagram illustrating a housing that encapsulates the coil according to the inductor manufacturing method.

FIG. 16 is a schematic diagram illustrating an inductor that is formed by removing carrier strips according to the inductor manufacturing method.

FIG. 17 is a flowchart of the inductor manufacturing method using a mold to form the housing according to an embodiment.

FIG. 18 is a schematic diagram illustrating the mold used by the inductor manufacturing method.

FIG. 19 is a schematic diagram illustrating that the semi-finished inductor in FIG. 14 is disposed into the mold according to the inductor manufacturing method.

FIG. 20 is a schematic diagram illustrating that a cavity of the mold is filled with a soft magnetic composite.

FIG. 21 is a schematic diagram illustrating that the soft magnetic composite in the cavity is compacted.

FIG. 22 is a schematic diagram illustrating that the first conductive lead frame and the second conductive lead frame are separated from the carrier strips.

FIG. 23 is a schematic diagram illustrating the bending of the coil according to another embodiment from a side view.

### DETAILED DESCRIPTION

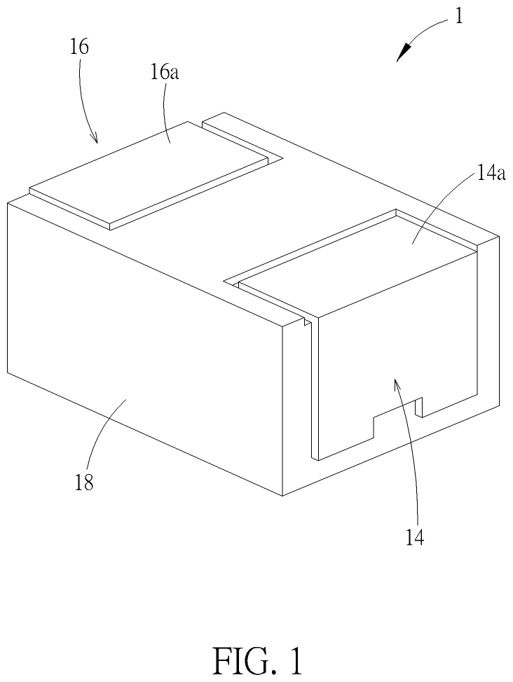

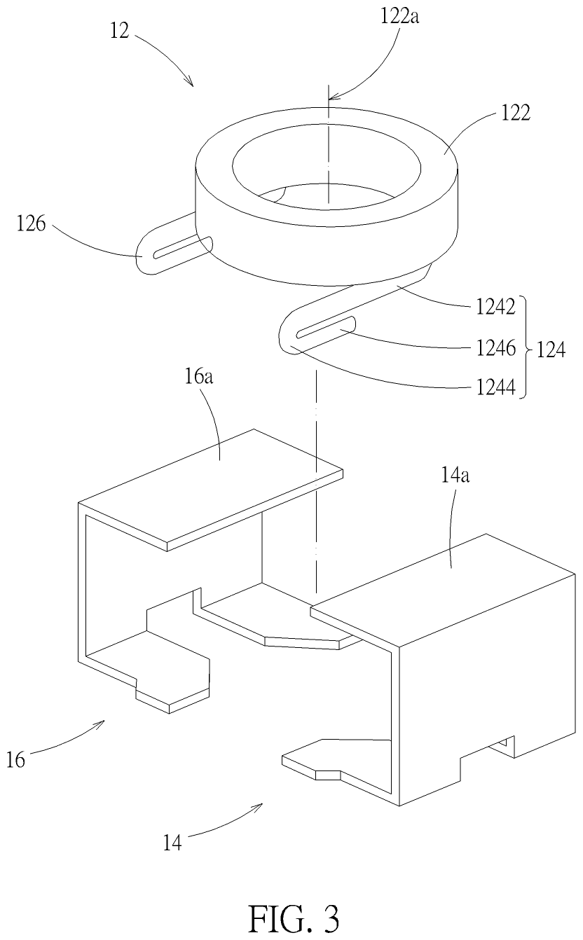

Please refer to FIG. 1 to FIG. 4. An inductor 1 according to a first embodiment includes a coil 12, a first conductive lead frame 14, a second conductive lead frame 16, and a housing 18. The coil 12 includes a coil body 122 (indicated by a round tube in the figures for drawing simplification), a first lead 124 protruding from the coil body 122, and a second lead 126 protruding from the coil body 122. In practice, the coil 12 can be wound by an insulated wire (such as an enameled wire). The two ends of the wire are used as the first lead 124 and the second lead 126. The first lead 124 is fixed onto the first conductive lead frame 14. The second lead 126 is fixed onto the second conductive lead frame 16. The housing 18 encapsulates the coil 12, part of the first conductive lead frame 14, and part of the second conductive lead frame 16. The exposed surfaces 14a and 16a of the first conductive lead frame 14 and the second conductive lead frame 16 are used as contacts of the inductor 1.

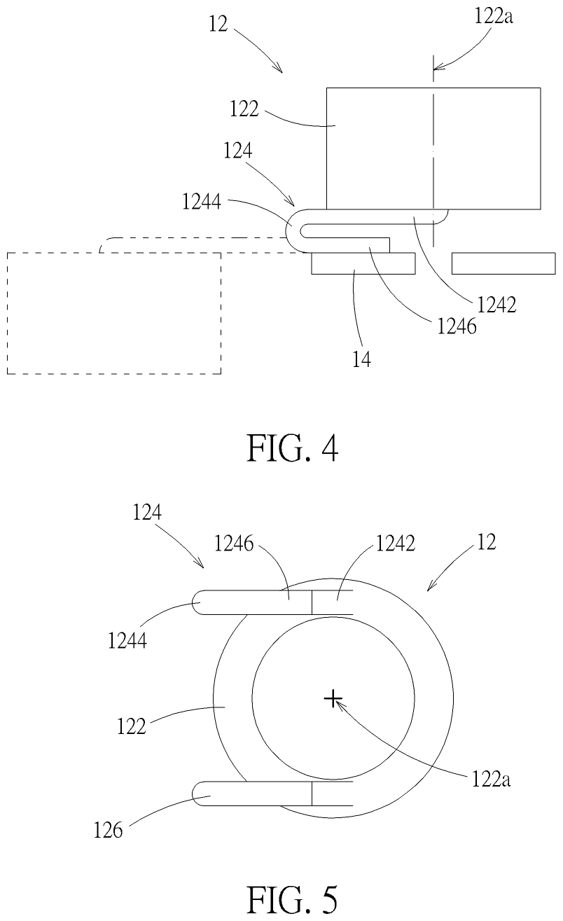

In the first embodiment, the first lead 124 has a coil connecting portion 1242, a U-bend portion 1244 and a frame connecting portion 1246 in sequence. The first lead 124 is connected to the coil body 122 through the coil connecting portion 1242. The first lead 124 is connected to the first conductive lead frame 14 through the frame connecting portion 1246. Along the wire axial of the first lead 124, the U-bend portion 1244 can increase the distance between the coil connecting portion 1242 and the frame connecting portion 1246. Thereby, during the process of electrically fixing the frame connecting portion 1246 to the first conductive lead frame 14 (such as removing the insulating outer layer of the frame connecting portion 1246 and spot welding it onto the first conductive lead frame 14), the portion 1244a of the first lead 124 that is used as the U-bend portion 1244 can be kept straight first, so that the coil body 122 is relatively far away from the frame connecting portion 1246 (shown in dashed lines in FIG. 4), which facilitates the spot welding.

Furthermore, in the first embodiment, the coil body 122 has a helical axis 122a (indicated by a chain line in the figures). The first lead 124 as a whole is located on a single side of the coil body 122 in a direction parallel to the helical axis 122a. On the other hand, the coil connecting portion 1242 and the frame connecting portion 1246 are located on the same side of the coil body 122 in the direction parallel to the helical axis 122a. For example, in the viewpoint of FIG. 4, the coil connecting portion 1242 and the frame connecting portion 1246 are located on the lower side of the coil body 122. Furthermore, please also refer to FIG. 5. The portion of the first lead 124 that is connected to the first conductive lead frame 14 (i.e., the frame connecting portion 1246) and the coil 122 partially or completely overlap in the direction parallel to the helical axis 122a (indicated by a cross mark in FIG. 5). This structural configuration is conducive to the reduction of the area occupied by the inductor 1 in the direction parallel to the helical axis 122a, and is also conducive to the manufacture of small-sized inductors. However, it is not limited thereto in practice.

Furthermore, in the first embodiment, the second lead 126 has substantially the same structure as the first lead 124, and also has a coil connecting portion, a U-bend portion, and a frame connecting portion. Therefore, for the description of the second lead 126, please directly refer to the relevant description of the first lead 124, which will not be repeated in addition.

In the first embodiment, the housing 18 is closely attached to the coil 12, and is formed, for example but not limited to, by heat-curing powder. The housing 18 passes through the coil 12 along the helical axis 122a. If the housing 18 is magnetic (e.g., formed by heat-curing magnetic powder), the housing 18 also serves as a magnetic core of the coil 12. In practice, the housing 18 can be realized by a combined structure. The combined structure may also include a magnetic material (such as a magnet) passing through the coil 12 along the helical axis 122a to serve as a magnetic core of the coil 12.

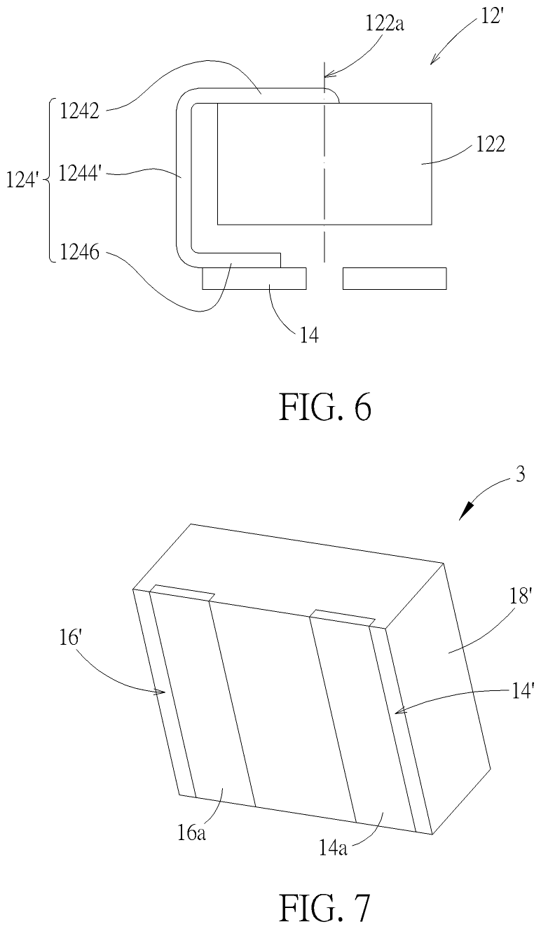

In addition, in the first embodiment, the plane where the first lead 124 is located is parallel to the helical axis 122a of the coil 12; however, it is not limited thereto in practice. For example, the plane where the first lead 124 is located is not parallel to the helical axis 122a (e.g., oblique or perpendicular). This structural configuration can shorten the overall length of the coil 12 in the direction parallel to the helical axis 122a. Furthermore, in the inductor 1, the coil connecting portion 1242 and the frame connecting portion 1246 are located on the same side of the coil body 122; however, it is not limited thereto in practice. As shown by FIG. 6, a coil 12′ according to another embodiment is similar in structure to the above coil 12, and uses the reference symbols of the components of the coil 12 in principle. For other descriptions of the coil 12′, please directly refer to the relevant descriptions of the coil 12, which will not be repeated in addition. A main difference between the coil 12′ and the coil 12 is that, in the coil 12′, the coil connecting portion 1242 and the frame connecting portion 1246 of the first lead 124′ are located on opposite sides of the coil body 122 in the direction parallel to the helical axis 122a, and the U-bend portion 1244′ straddles the coil body 122 in the direction. This structural configuration can also make the overall length of the coil 12′ in the direction parallel to the helical axis 122a shorter than the overall length of the coil 12, and make the length of the U-bend portion 1244′ of the coil 12′ longer than the length of the U-bend portion 1244 of the coil 12 (which facilitates fixing the first lead 124′ of the coil 12′ onto the first conductive lead frame 14).

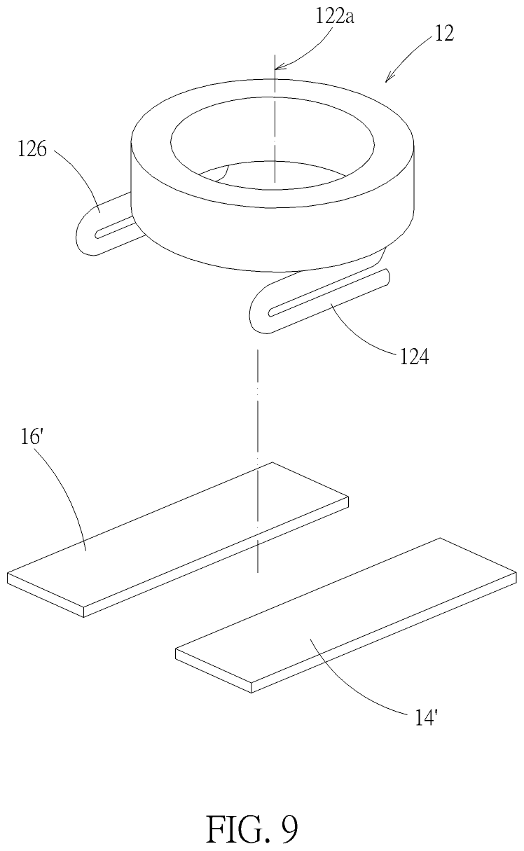

Please refer to FIG. 7 to FIG. 9. An inductor 3 according to a second embodiment is similar in structure to the above inductor 1, and uses the reference symbols of the components of the inductor 1 in principle. For other descriptions of the inductor 3, please directly refer to the relevant descriptions of the inductor 1, which will not be repeated in addition. A main difference between the inductor 3 and the inductor 1 is that the first conductive lead frame 14′ and the second conductive lead frame 16′ of the inductor 3 are in the shape of long strips. The first conductive lead frame 14′ and the second conductive lead frame 16′ are structurally parallel without bending, and can be used directly as the contact of the inductor 3 after the housing 18′ is formed. This structural configuration can make the overall length of the inductor 3 in the direction parallel to the helical axis 122a (i.e., the height of the inductor 3) shorter than the overall length of the inductor 1.

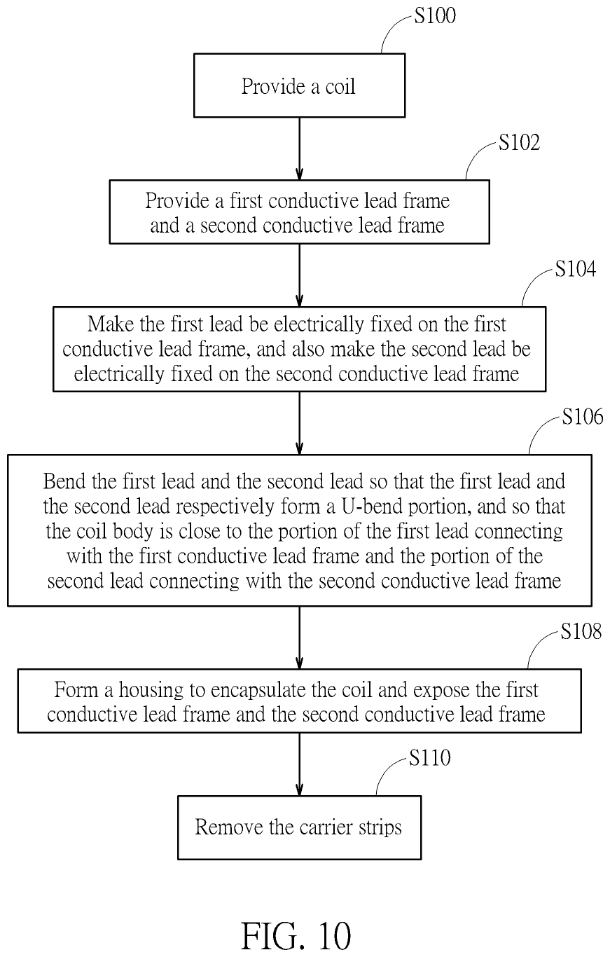

Please refer to FIG. 10, which shows an inductor manufacturing method according to a third embodiment. To simplify the description, the manufacture of the inductor 3 is taken as an example. However, the inductor 3 is not limited to be formed by the inductor manufacturing method in practice. As shown by the step S100 in FIG. 10, the inductor manufacturing method is to provide a coil 12a, as shown by FIG. 11. Therein, the coil 13 includes a coil body 123, a first lead 125 protruding from the coil body 123, and a second lead 127 protruding from the coil body 123. The first lead 125 has a coil connecting portion 1252, a frame connecting portion 1256, and a middle portion 1254 between the coil connecting portion 1252 and the frame connecting portion 1256. The first lead 125 is connected to the coil body 123 through the coil connecting portion 1252. The frame connecting portion 1256 is located at the end portion of the first lead 125; however, it is not limited thereto in practice. The second lead 127 has substantially the same structure as the first lead 125, and also has a coil connecting portion, a frame connecting portion, and a middle portion, which will not be repeated in addition.

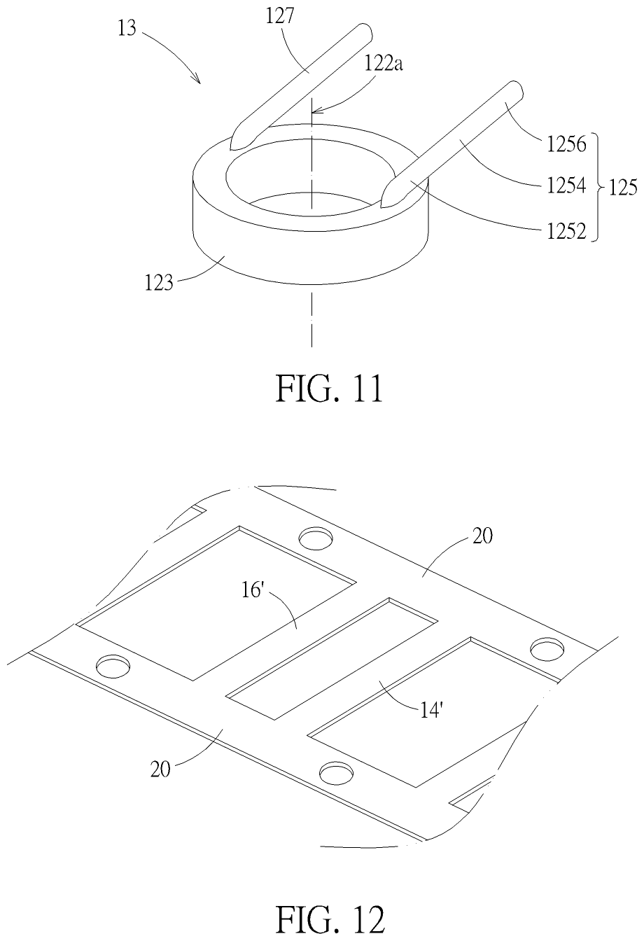

As shown by the step S102 in FIG. 10, the inductor manufacturing method is to provide a first conductive lead frame 14′ and a second conductive lead frame 16′, as shown by FIG. 12. Therein, both ends of each of the first conductive lead frame 14′ and the second conductive lead frame 16′ are connected to carrier strips 20, which facilitates the positioning of the semi-finished inductor 3 during the manufacturing process.

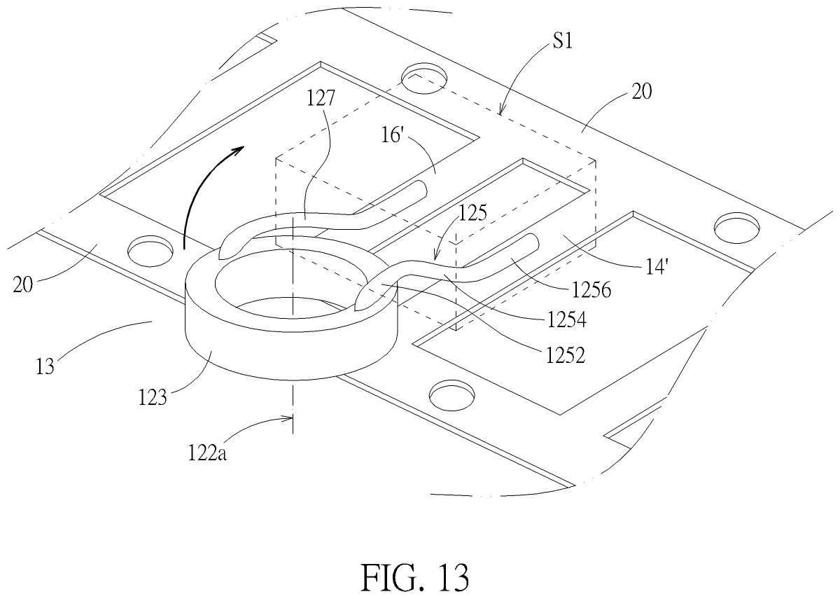

As shown by the step S104 in FIG. 10, the inductor manufacturing method is to make the first lead 125 be electrically fixed on the first conductive lead frame 14′, and also make the second lead 127 be electrically fixed on the second conductive lead frame 16′, as shown by FIG. 13. Therein, the first lead 125 is electrically fixed on the first conductive lead frame 14′ through the frame connecting portion 1256. The same is true for the second lead 127, which will not be repeated in addition. The electrical fixing of the first lead 125 and the second lead 127 on the first conductive lead frame 14′ and the second conductive lead frame 16′ can be realized by spot welding; however, it is not limited thereto in practice. In addition, in principle, in the above fixing process, making the coil body 123 be separated from the space S1 above the frame connecting portions of the first lead 125 and the second lead 127 (indicated by a dashed box in the figure, i.e., the space where the coil body 123 is located after the subsequent bending of the first lead 125 and second lead 127) can increase the working space required for the above fixing operation, which facilitates the fixing operation (for example, it is convenient for the electrodes of the spot welding machine to contact the workpiece smoothly) and is beneficial to avoid damage to the coil body 123 (for example, prevent the electrodes of the spot welding machine from touching the coil body 123). Therefore, in FIG. 13, although the first lead 125 and the second lead 127 are not straight now due to the structural interference of the coil body 123 with the first conductive lead frame 14′ and the second conductive lead frame 16′, the first lead 125 and the second lead 127 at this time can still make the coil body 123 be relatively far away from the aforementioned space S1. Such structural configuration still has the effect of facilitating the fixing operation and avoiding damage to the coil body 123.

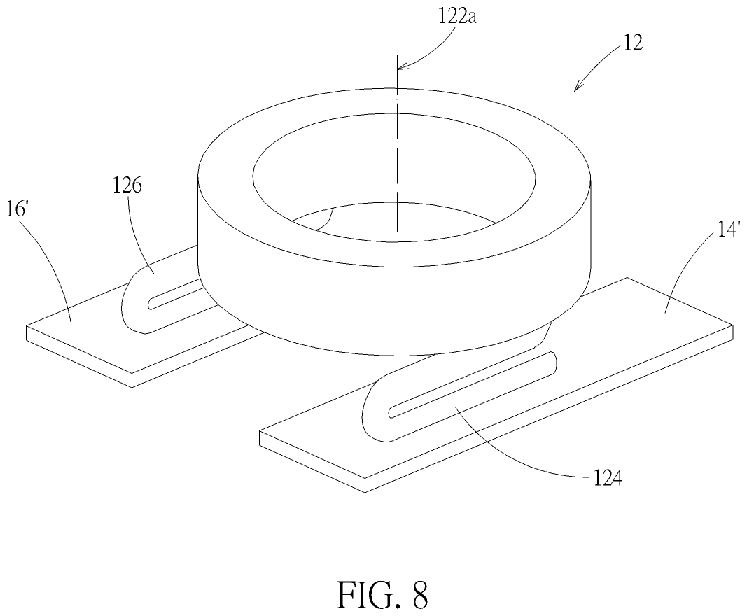

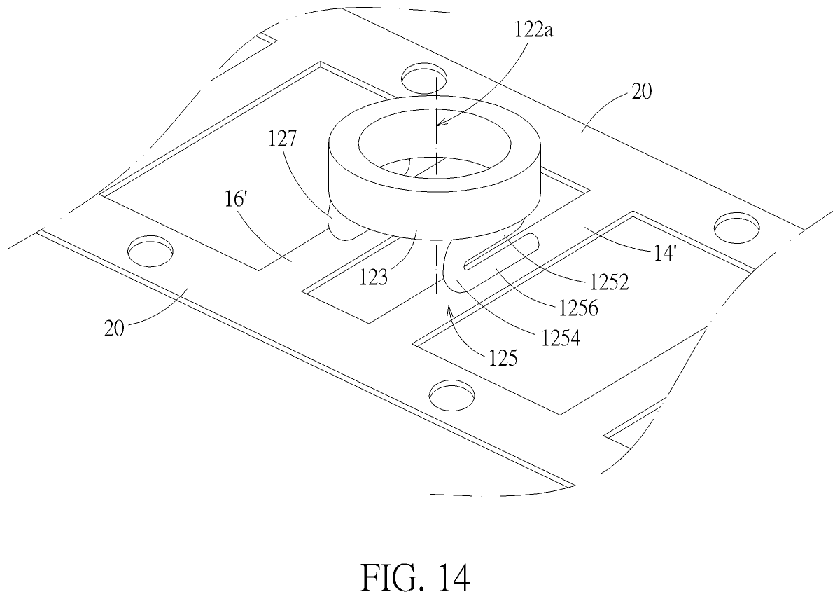

As shown by the step S106 in FIG. 10, the inductor manufacturing method is to bend the first lead 125 and the second lead 127 so that the first lead 125 and the second lead 127 respectively form a U-bend portion, and so that the coil body 123 is close to the portion of the first lead 125 (i.e. the frame connecting portion 1256) that connects with the first conductive lead frame 14′ and the portion of the second lead 127 (i.e. the frame connecting portion of the second lead 127) that connects with the second conductive lead frame 16′, as shown by FIG. 14. Therein, the U-bend portion of the first lead 125 is formed by the middle portion 1254; the same is true for second lead 127, which will not be repeated in addition. In practice, the above bending can be realized through a jig, such as fixing the first conductive lead frame 14′ (together with the frame connecting portion 1256) and rotating the coil body 123 relative to the first conductive lead frame 14′ (of which the rotation direction can refer to the arrow direction in FIG. 13) so that the middle portion 1254 is bent to form a U-bend portion. Furthermore, the structural configuration of the coil 13 in FIG. 14 is the same as the structural configuration of the coil 12 of the inductor 3 (as shown in FIG. 8). Furthermore, after the coil 13 is bent, the portion of the first lead 125 connected to the first conductive lead frame 14′ and the portion of the second lead 127 connected to the second conductive lead frame 16′ overlap with the coil body 123 in the direction parallel to the helical axis 122a of the coil body 123, whose schematic diagram is similar to FIG. 5 and therefore, will not be shown in other figure.

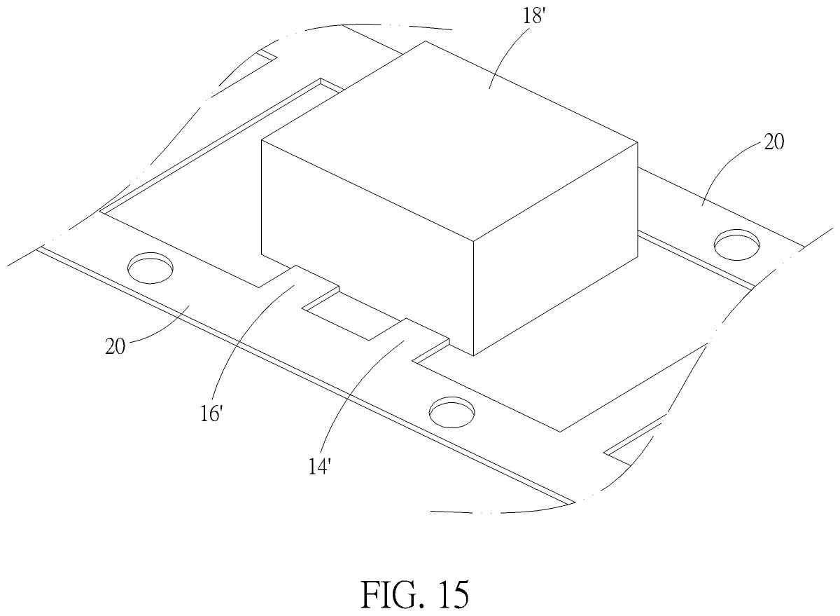

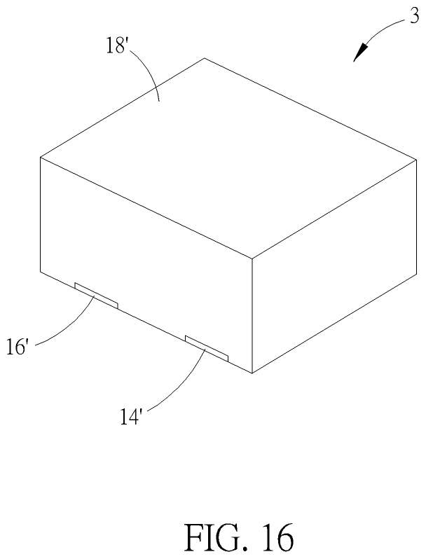

As shown by the step S108 in FIG. 10, the inductor manufacturing method is to form a housing 18′ to encapsulate the coil 13 and expose the first conductive lead frame 14′ and the second conductive lead frame 16′, as shown by FIG. 15. Afterwards, as shown by the step S110 in FIG. 10, the inductor manufacturing method is to remove the carrier strips 20. Finally, an inductor 3 is formed, as shown by FIG. 16 (seeing FIG. 7 for another view of the inductor 3). In addition, for other descriptions of the inductor 3 produced by the inductor manufacturing method, please refer to the relevant descriptions of the inductor 3, which will not be repeated in addition.

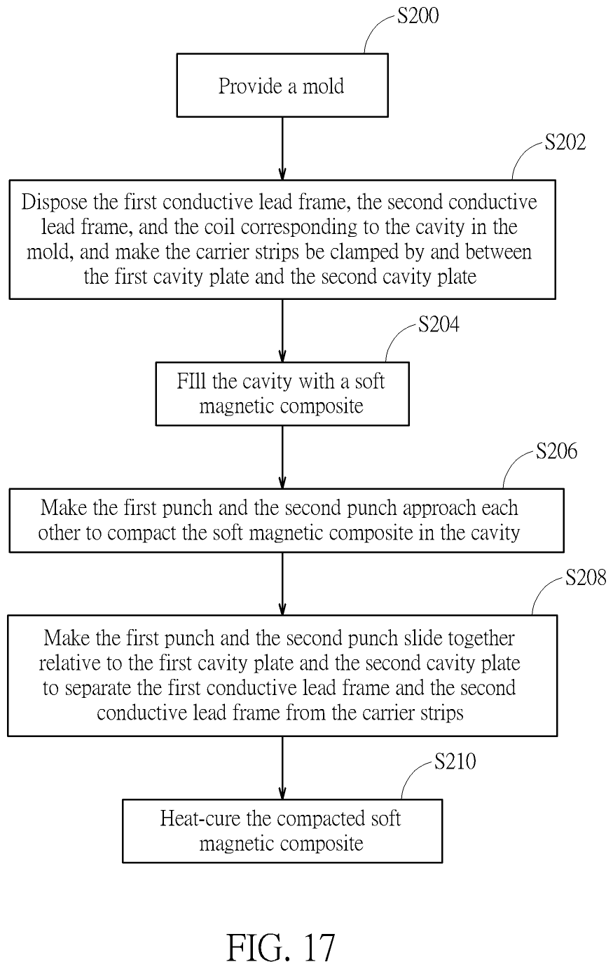

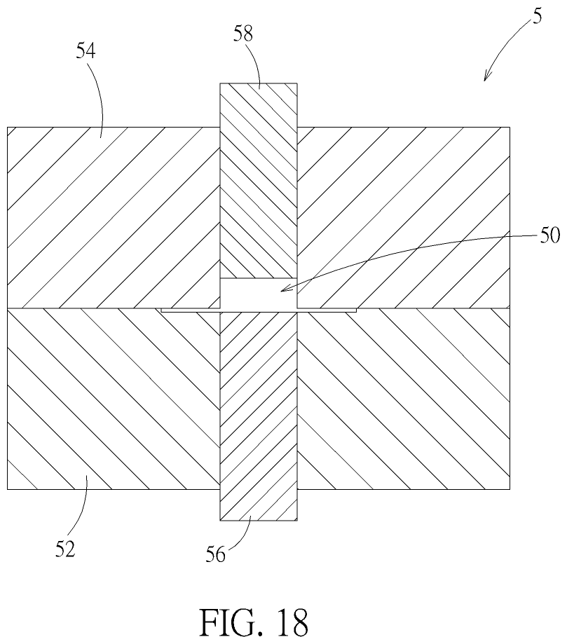

In practice, in the inductor manufacturing method, the forming of the housing 18′ in the step S108 can be implemented through heat-curing soft magnetic composite. Furthermore, the removal of the carrier strips 20 in step S110 can also be implemented using a jig. Therefore, in practice, the above steps S108 and S110 can be integrated and realized through a mold. Please refer to FIG. 17. As shown by the step S200, in an embodiment, the inductor manufacturing method is to provide a mold 5, as shown by FIG. 18. The mold 5 includes a first cavity plate 52, a second cavity plate 54 movably disposed relative to the first cavity plate 52, a first punch 56 movably disposed on the first cavity plate 52, and a second punch 58 movably disposed on the second cavity plate 54. When the mold 5 is closed, a cavity 50 is formed.

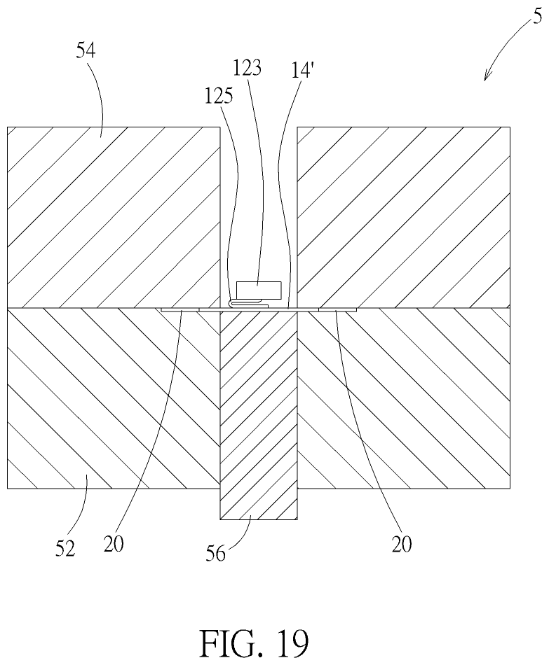

As shown by the step S202 in FIG. 17, the inductor manufacturing method is to dispose the first conductive lead frame 14′, the second conductive lead frame 16′, and the coil 13 corresponding to the cavity 50 in the mold 5, and make the carrier strips 20 be clamped by and between the first cavity plate 52 and the second cavity plate 54, as shown by FIG. 19. Therein, for the convenience of reading the drawing, the coil 13, the conductive lead frames 14′ and 16′, and the carrier strips 20 are shown without hatching.

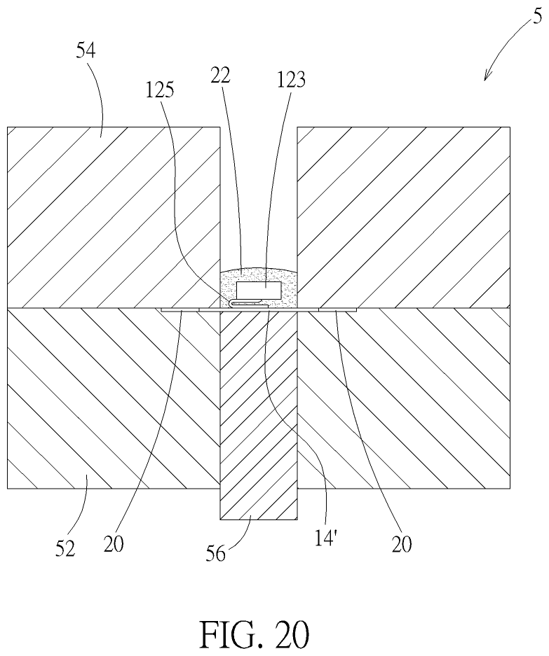

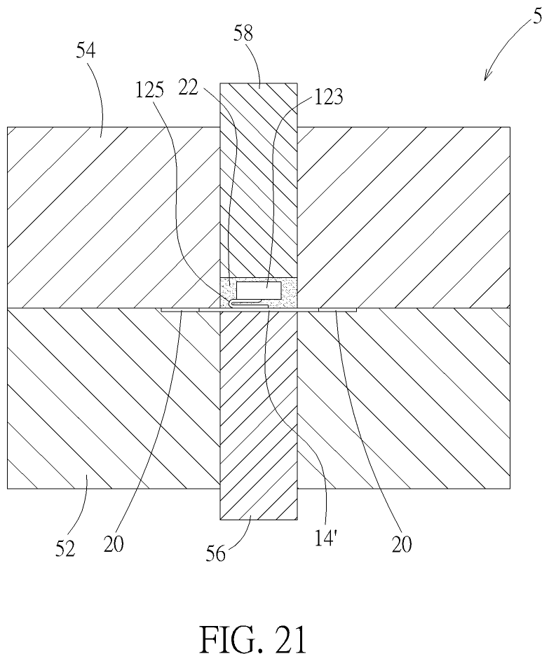

As shown by the step S204 in FIG. 17, the inductor manufacturing method is to fill the cavity 50 with a soft magnetic composite 22, as shown by FIG. 20. Therein, the soft magnetic composite 22 will also fill the space inside the coil body 123 (not shown in the figure). Afterwards, as shown by the step S206 in FIG. 17, the inductor manufacturing method is to make the first punch 56 and the second punch 58 approach each other to compact the soft magnetic composite 22 in the cavity 50, as shown by FIG. 21.

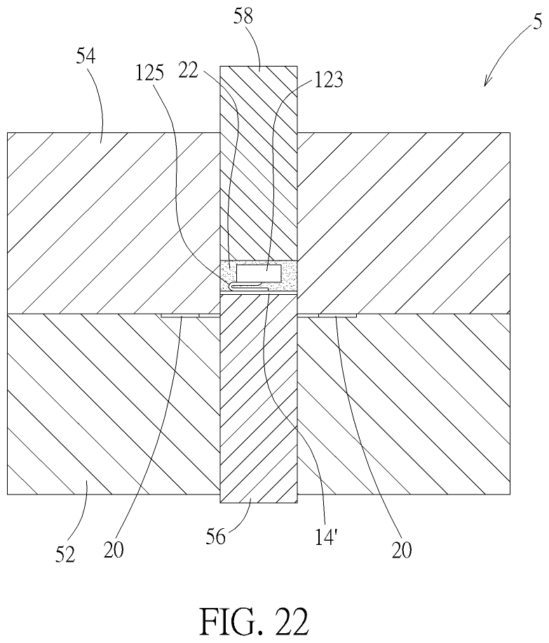

As shown by the step S208 in FIG. 17, the inductor manufacturing method is to make the first punch 56 and the second punch 58 slide together relative to the first cavity plate 52 and the second cavity plate 54 to separate the first conductive lead frame 14′ and the second conductive lead frame 16′ from the carrier strips 20, as shown by FIG. 22. Afterwards, as shown by the step S210 in FIG. 17, the inductor manufacturing method is to heat-cure the compacted soft magnetic composite 22, and then an inductor 3 is obtained, as shown by FIG. 16 (seeing FIG. 7 for another view of the inductor 3).

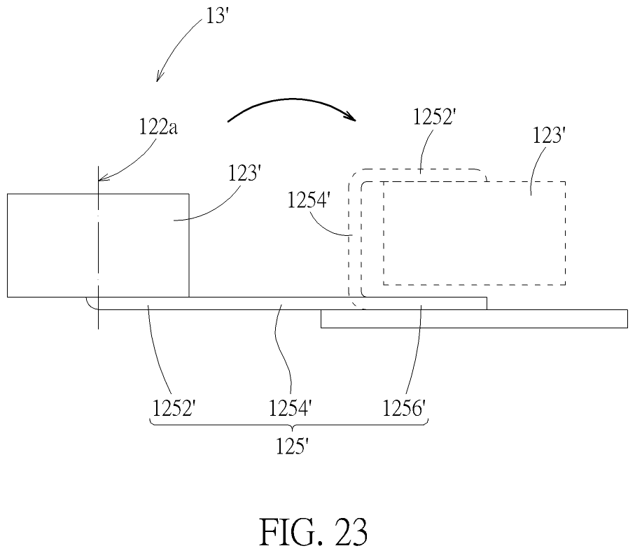

In addition, in the third embodiment, as shown by the step S106 and FIG. 14, the inductor manufacturing method is to bend the first lead 125 so that the first lead 125 as a whole is located on a single side of the coil body 123 in the direction parallel to the helical axis 122a. The same is true for the second lead 127, which will not be repeated in addition. However, it is not limited thereto in practice. For example, as shown by FIG. 23, a coil 13′ according to another embodiment is similar in structure to the above coil 13, and uses the reference symbols of the components of the coil 13 in principle. For other descriptions of the coil 13′, please directly refer to the relevant descriptions of the coil 13, which will not be repeated in addition. A main difference between the coil 13′ and the coil 13 is that the middle portion 1254′ of the first lead 125′ of the coil 13′ is longer than the middle portion 1254 of the first lead 125 of the coil 13, so after bending the coil 13′ (shown in dashed lines in the figure; the bending direction is indicated by the arrow in the figure), the coil connecting portion 1252′ and the frame connecting portion 1256′ of the first lead 125′ are located on opposite sides of the coil body 123′ in the direction parallel to the helical axis 122a, the U-bend portion formed by bending the middle portion 1254′ straddles the coil body 123′ in the direction. The length of the middle portion 1254′ of the first lead 125′ is relatively long, so during the process of fixing the first lead 125′ onto the first conductive lead frame 14′, a larger working space can be obtained, and better protection can be provided for the coil body 123′.

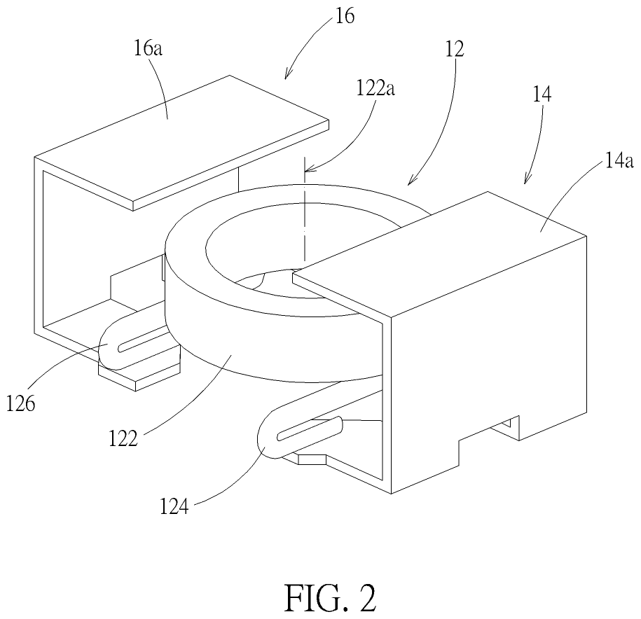

In addition, the third embodiment is to illustrate the inductor manufacturing method by taking the manufacture of the inductor 3 as an example, but in practice, the inductor manufacturing method can also be illustrated by taking the manufacture of the inductor 1 as an example. The above two manufacturing methods are essentially the same. A main difference is that the first conductive lead frame 14 and the second conductive lead frame 16 of the inductor 1 are not simple flat structures (referring to FIG. 2), so in principle, the first conductive lead frame 14 and second conductive lead frame 16 after housing 18 is heat-cured (e.g., formed by heat-curing powder) need to undergo a bending process so as to be closely attached to the surfaces of the housing 18 to complete the inductor 1. Therefore, the manufacturing method of the inductor 1 can be realized by referring to the manufacturing method of the inductor 3 and the above description, and will not be repeated in addition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inductor, comprising:
a coil, the coil comprising a coil body and a first lead protruding from the coil body, the first lead having a U-bend portion;
a first conductive lead frame, the first lead being electrically fixed to the first conductive lead frame; and
a housing, the housing encapsulating the coil and exposing the first conductive lead frame.

2. The inductor according to claim 1, wherein the coil body has a helical axis, the first lead as a whole is located on a single side of the coil body in a direction parallel to the helical axis.

3. The inductor according to claim 1, wherein the coil body has a helical axis, the first lead has a coil connecting portion and a frame connecting portion, the first lead is connected to the coil body through the coil connecting portion, the first lead is connected to the first conductive lead frame through the frame connecting portion, and the coil connecting portion and the frame connecting portion are located on the same side of the coil body in a direction parallel to the helical axis.

4. The inductor according to claim 1, wherein the coil body has a helical axis, the first lead has a coil connecting portion and a frame connecting portion, the first lead is connected to the coil body through the coil connecting portion, the first lead is connected to the first conductive lead frame through the frame connecting portion, and the coil connecting portion and the frame connecting portion are located on opposite sides of the coil body in a direction parallel to the helical axis.

5. The inductor according to claim 1, wherein the coil body has a helical axis, and a portion of the first lead that connects with the first conductive lead frame and the coil body overlap in a direction parallel to the helical axis.

6. The inductor according to claim 1, wherein the housing contains a magnetic material and passes through the coil.

7. The inductor according to claim 1, wherein the coil comprises a second lead protruding from the coil body, the inductor comprises a second conductive lead frame, the second lead is electrically fixed to the second conductive lead frame, the housing exposes the second conductive lead frame, and the first conductive lead frame and the second conductive lead frame are structurally parallel.

8. An inductor manufacturing method, comprising the following steps of:
(a) providing a coil, the coil comprising a coil body and a first lead protruding from the coil body;
(b) providing a first conductive lead frame;
(c) making the first lead be electrically fixed on the first conductive lead frame;
(d) bending the first lead so that the first lead forms a U-bend portion and the coil body is close to a portion of the first lead that connects with the first conductive lead frame; and
(e) forming a housing to encapsulate the coil and expose the first conductive lead frame.

9. The inductor manufacturing method according to claim 8, wherein the coil body has a helical axis, and in the step (d), the first lead is bent so that the first lead as a whole is located on a single side of the coil body in a direction parallel to the helical axis.

10. The inductor manufacturing method according to claim 8, wherein the coil body has a helical axis, the first lead has a coil connecting portion and a frame connecting portion, the first lead is connected to the coil body through the coil connecting portion, and in the step (c), the first lead is electrically fixed on the first conductive lead frame through the frame connecting portion, and in the step (d), the first lead is bent so that the coil connecting portion and the frame connecting portion are located on the same side of the coil body in a direction parallel to the helical axis.

11. The inductor manufacturing method according to claim 8, wherein the coil body has a helical axis, the first lead has a coil connecting portion and a frame connecting portion, the first lead is connected to the coil body through the coil connecting portion, and in the step (c), the first lead is electrically fixed on the first conductive lead frame through the frame connecting portion, and in the step (d), the first lead is bent so that the coil connecting portion and the frame connecting portion are located on opposite sides of the coil body in a direction parallel to the helical axis.

12. The inductor manufacturing method according to claim 8, wherein the coil body has a helical axis, and in the step (d), the first lead is bent so that the portion of the first lead that connects with the first conductive lead frame and the coil body overlap in a direction parallel to the helical axis.

13. The inductor manufacturing method according to claim 8, wherein in the step (b), the first conductive lead frame is connected to a carrier strip, and the step (e) is implemented by the following steps of:
providing a mold, the mold forming a cavity and comprising a first cavity plate, a second cavity plate movably disposed opposite to the first cavity plate, a first punch slidably disposed on the first cavity plate, and a second punch slidably disposed on the second cavity plate opposite to the first punch;
disposing the first conductive lead frame and the coil corresponding to the cavity in the mold, and making the carrier strip be clamped by and between the first cavity plate and the second cavity plate;
filling the cavity with a soft magnetic composite;
making the first punch and the second punch approach each other to compact the soft magnetic composite in the cavity;
making the first punch and the second punch slide together relative to the first cavity plate and the second cavity plate to separate the first conductive lead frame from the carrier strip; and
heat-curing the compacted soft magnetic composite.
